(19) United States
(12) Patent Application Publication
(10) Pub. No.: US 2004/0070170 A1
(43) Pub. Date: Apr. 15, 2004

(54) Jaw assembly for fifth wheel hitch assembly

(76) Inventors: Thomas W. Lindenman, South Bend, IN (US); Richard W. McCoy, Granger, IN (US); Michael A. Hoopes, White Pigeon, MI (US)

Correspondence Address: KING & SCHICKLI, PLLC, 247 NORTH BROADWAY, LEXINGTON, KY, 40507, US

(21) Appl. No.: 10/652,419

(22) Filed: Aug. 29, 2003

Related U.S. Application Data
(60) Provisional application No. 60/408,263, filed on Sep. 5, 2002.

(51) Int. Cl. B62D 53/08

(52) U.S. Cl. 280/433

(57) ABSTRACT

The present invention relates to a jaw assembly and a fifth wheel hitch assembly incorporating that jaw assembly. The jaw assembly includes a control handle, a jaw bolt connected to the control handle and a biasing element. The jaw bolt includes an arcuate edge portion having a radius of curvature of between about 1.24 and about 3.24 inches. The fifth wheel hitch assembly includes a frame, a head assembly mounted on that frame and the above-described jaw assembly carried by that head assembly.

This application claims the benefit of U.S. Provisional Patent Application Serial No. 60/408,263 filed Sep. 5, 2002.

### TECHNICAL FIELD

The present invention relates generally to the trailer towing field and, more particularly, to an improved jaw bolt for the jaw assembly of a fifth wheel hitch assembly.

### BACKGROUND OF THE INVENTION

Fifth wheel hitch assemblies for towing a trailer behind a towing vehicle have long been known in the art. Examples of state-of-the-art fifth wheel hitches include those presently manufactured by Cequent Towing Products, Inc., 47774 Anchor Court, Plymouth, Mich. 48170 under various U.S. Pat. Nos. including 5,516,137 to Kass et al. and 5,529,329 to McCoy.

These state-of-the-art fifth wheel hitch assemblies include a support frame for mounting the assembly to the towing vehicle, such as, for example, to the bed of a pickup truck. The support frame includes a pair of mounting rails that are bolted to the bed and/or frame of the truck, side brackets that are releasably mounted to the rails and a head support mounted to the side brackets. A head assembly is mounted to the head support by means of a trunion arrangement allowing for pivotal fore-and-aft movement. The head assembly includes a jaw assembly, operable by means of a control handle, that is specially adapted to releasably engage and hold the king pin of a trailer desired to be towed by the towing vehicle.

While such state-of-the-art fifth wheel hitch assemblies provide excellent overall performance and dependable operation, it is believed that improvements in design are still possible. More specifically, it is desired to manufacture such hitch assemblies at reduced cost without compromising the overall performance characteristics of the hitch assemblies when in use in the field. State-of-the-art fifth wheel hitches of prior art design generally include a relatively complex jaw assembly that includes a large number of component parts. As a result, most jaw assemblies of prior art design are expensive to manufacture. The complicated operation and interaction of the high number of parts also increases the difficulty of assembly. A need is therefore identified for an improved jaw assembly for a fifth wheel hitch.

### SUMMARY OF THE INVENTION

The present invention as described herein is a fifth wheel hitch assembly including a frame, a head assembly pivotally mounted to the frame and a jaw assembly connected to the head assembly. The jaw assembly includes a control handle, a jaw bolt displaceable between an open position and a locking position and a biasing element for urging the jaw bolt toward the locking position. The jaw bolt is characterized by having a leading edge wherein at least a portion thereof has a radius of curvature of between about 1.24 inches to about 3.24 inches, and more typically about 2.24 inches.

In accordance with an additional aspect of the present invention a jaw assembly for a fifth wheel hitch assembly is claimed. As described above that jaw assembly includes a control handle, a jaw bolt connected to the control handle and a biasing element. The jaw bolt is characterized by having a leading edge wherein at least a portion thereof has a radius of curvature of between about 1.24 inches to about 3.24 inches, and more typically about 2.24 inches.

### BRIEF DESCRIPTION OF THE DRAWINGS

The accompanying drawings incorporated in and forming a part of the specification, illustrate several aspects of the present invention and together with the description serve to explain the principles of the invention.

FIG. 1 is a perspective view of the fifth wheel hitch assembly of the present invention;

FIG. 2 is a top plan view of the fifth wheel hitch assembly shown in FIG. 1;

FIG. 3a is a detailed transverse cross-sectional view of the jaw assembly illustrated in full line in the locking position and in phantom line in the open position;

FIG. 3b is a detailed cross-sectional view along line 3b-3b in FIG. 4 showing the jaw assembly in the locked position;

FIG. 4 is a detailed top plan view showing the jaw assembly of the present invention connected to the head assembly of the fifth wheel hitch assembly, with the jaw bolt shown in full line in the locking position and in phantom line in the open position; and

FIG. 5 is a top plan view of the jaw bolt clearly showing the leading edge thereof including the arcuate portion, and further showing the shoulder on the control handle for engaging the side wall of the head assembly and holding the jaw assembly in the open position.

Reference will now be made in detail to the present preferred embodiment of the invention, an example of which is illustrated in the accompanying drawings.

### DETAILED DESCRIPTION OF THE INVENTION

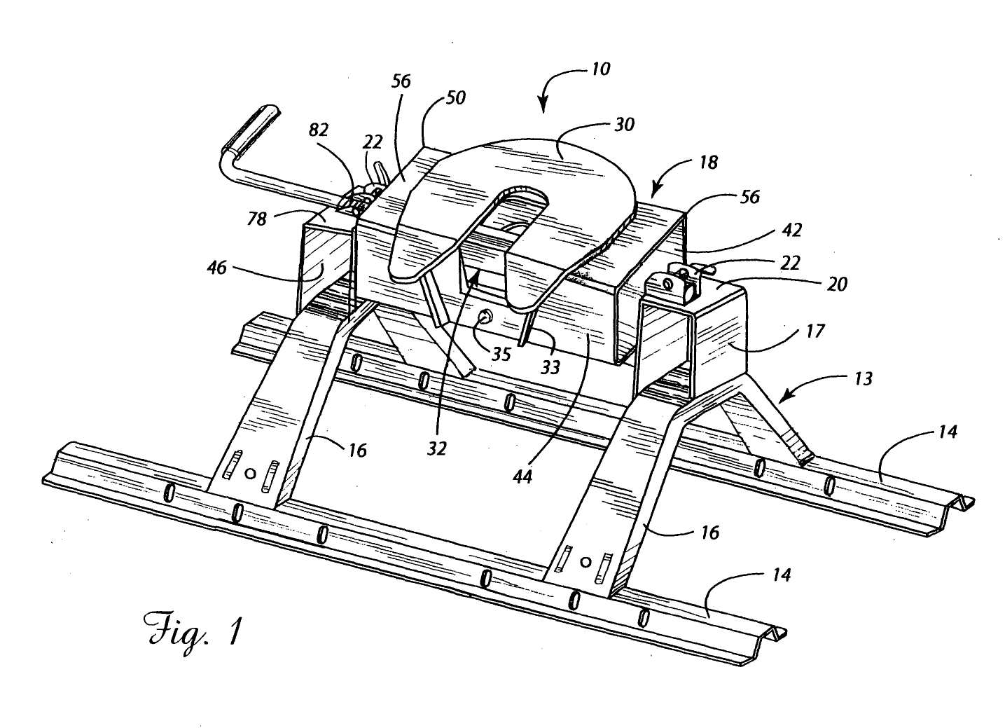

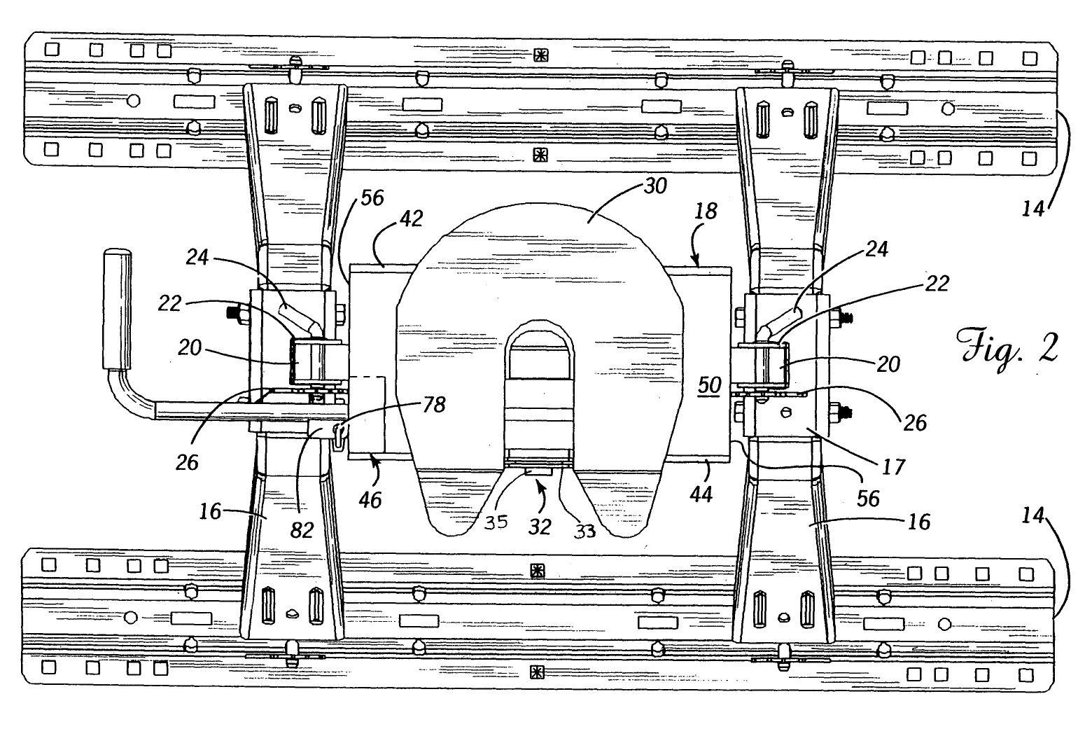

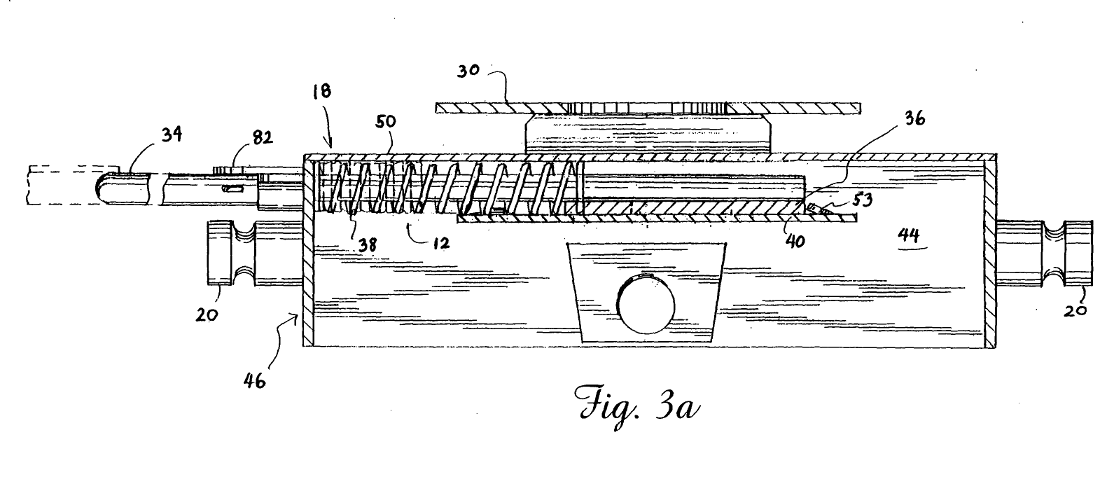

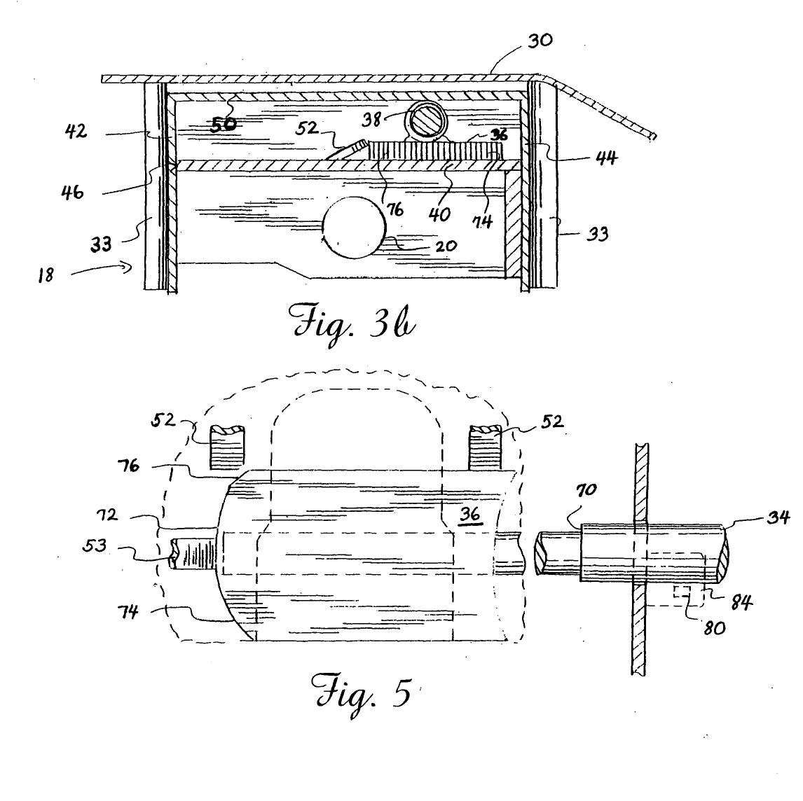

Reference is now made to drawing FIGS. 1 and 2 showing the fifth wheel hitch assembly 10 of the present invention. Such a fifth wheel hitch assembly 10 incorporates a jaw assembly 12 as illustrated in detail in FIGS. 3a, 3b and 4 and described below.

The fifth wheel hitch assembly 10 includes a support frame generally designated by reference numeral 13. The support frame 13 includes a pair of spaced, parallel rails 14 that are bolted to the frame of the towing vehicle (not shown), a pair of side brackets 16 that are releasably secured to the rails so as to straddle the rear axle of the towing vehicle and a cross member head support 17 extending between the side brackets. A head assembly 18 is mounted to the head support 17. The head assembly 18 includes two, opposed and laterally projecting pivot pins 20. Each pivot pin 20 is received in a cooperating cradle 22, one provided at each opposing lateral end of the head support 17 and secured in position by a connecting pin 24. Accordingly, the head assembly 18 pivots in the fore-and-aft direction on the head support 17 during towing of a trailer. As further known in the art the connecting pins 24 may be secured in position by means of cooperating links 26 and a padlock 28 as desired.

As should further be appreciated from reviewing FIGS. 1 and 2, the head assembly 18 includes a skid plate 30 that includes a throat 32 for receipt and passage of the king pin of a trailer to be connected to the towing vehicle. The skid plate 30 may be pivotally connected to the head assembly 18 by depending mounting brackets 33 and pivot pins 35 at the front and rear thereof. This allows the skid plate 30 to pivot from side-to-side within a limited movement range.

As best shown with reference to FIGS. 3a, 3b and 4, the jaw assembly 12 includes a control handle 34, a jaw bolt 36 secured to one end of the control handle and a helical compression spring 38 received concentrically around the control handle 34. As will become apparent from the following description, the jaw assembly 12 is displaceable relative to the head assembly 18 between an open position shown in phantom line in FIGS. 3a, 4 and a closed position shown in full line in FIGS. 3a, 4.

More specifically, the head assembly 18 includes a substantially U-shaped base plate 40 that is welded or otherwise secured to the front and rear walls 42, 44 of the head assembly housing 46. The base plate 40, the top wall 50 and the rear wall 44 all include notches aligned with the throat 32 of the skid plate 30 so as to allow the necessary clearance to receive the king pin of a trailer.

As should be appreciated, the jaw bolt 36 of the jaw assembly 18 slides along a guide track defined by the underlying base plate 40, the overlying top wall 50 of the head assembly housing 46, the rear wall 44 and a pair of cooperating guide tabs 52 formed in or carried by the base plate 40 opposite the rear wall. Thus, the base plate 40 and top wall 50 define the vertical limits of the guide track while the tabs 52 and rear wall 44 define the horizontal limits of the guide track. A stop tab 53 formed in or carried by the base plate 40 prevents spring 38 from biasing jaw bolt 36 beyond the desired locking or closed position. The guide track is straight and aligned with the control handle 34.

It should also be appreciated that the control handle 34 extends through an aperture 54 in the side wall 56 of the head assembly housing 46. Specifically, the aperture 54 is sized to be just slightly larger than the cross section of the control handle 34 with sufficient clearance to allow for free sliding movement of the control handle. Engagement of the control handle 34 with the margins of the side wall 56 defining the aperture 54 and the capturing of the jaw bolt 36 between the base plate 40, top wall 50, rear wall 44 and guide tabs 52 ensure smooth sliding operation of the jaw assembly 12 between the open and locking positions without any sticking or binding.

As should be appreciated, a first end of the spring 38 engages the inner surface of the side wall 56 while the second end of the spring 38 engages the jaw bolt 36. Accordingly, the spring 38 serves as a biasing element that effectively urges the jaw assembly 12 to the closed position shown in full line in FIGS. 3a, 4. In this position the jaw bolt 36 effectively captures the king pin of a trailer in the throat 32 of the assembly 18. In this position the weight of the trailer is supported on the skid plate 30 with the trailer king pin freely rotating with respect to but securely held by the jaw assembly 12 of the fifth wheel hitch assembly 10 to allow trailer towing.

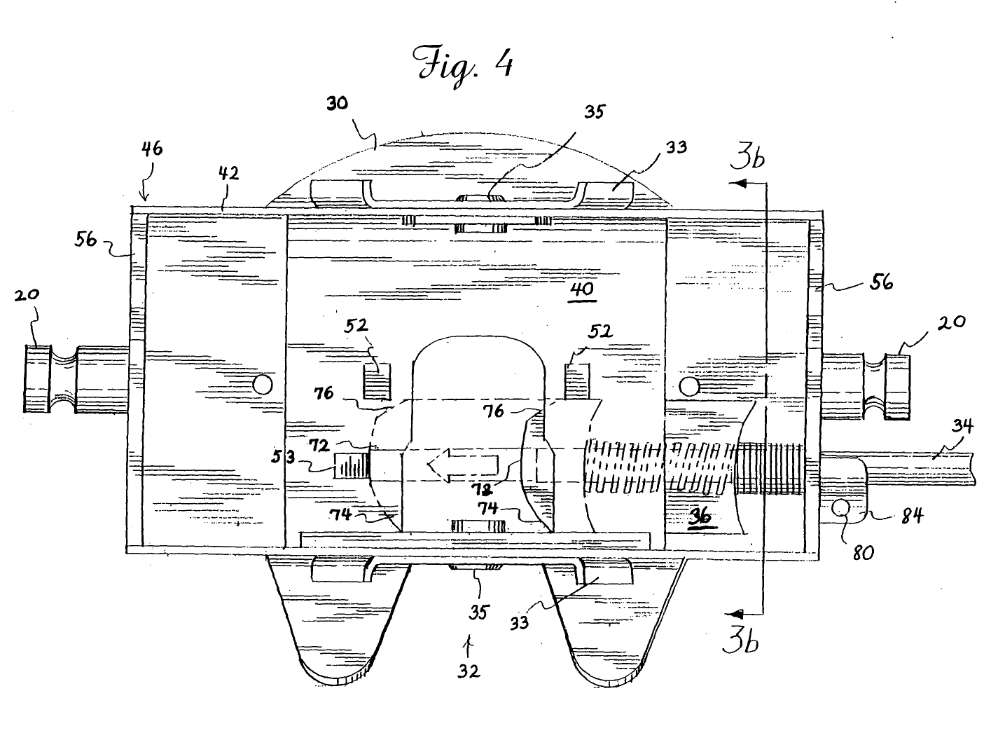

Following towing, the jaw assembly 12 maybe displaced to the open position shown in phantom line in FIGS. 3a, 4 to allow release of the king pin of the trailer. More specifically, the control handle 34 is unlocked and pulled in an outward direction from the side wall 56 of the head assembly 18 and the control handle is shifted slightly sideways to engage a shoulder 70 (best seen in FIG. 5) in the control handle on the margin of the side wall 56 defining the aperture 54. Of course, it will be appreciated that any suitable means for maintaining jaw assembly 12 in the open position may be employed, such as a groove or notch instead of shoulder 70. This locks the jaw assembly 12 in the open position against the biasing force of the spring 38 thereby opening the throat 32 of the fifth wheel hitch assembly 10 and allowing passage of the king pin of the trailer and detachment of the trailer from the fifth wheel hitch assembly 10. This is done by slowly pulling the towing vehicle in a forward direction away from the trailer.

The connection of a trailer to a towing vehicle through the hitch assembly 10 will now be described. As should be appreciated from reviewing FIG. 4, the jaw bolt 36 of the jaw assembly 12 includes a leading edge 72, a portion 74 of which has a radius of curvature of between about 1.24 inches to about 3.24 inches, and more typically about 2.24 inches. Advantageously, this arcuate leading edge portion 74 functions to allow the king pin of the trailer to freely enter the throat 32 of the fifth wheel hitch assembly 10. More specifically, when in the open position, the arcuate leading edge portion 74 of the jaw bolt 36 extends partially into the throat 32. As the vehicle is backed carefully toward the trailer, the king pin enters the throat 32 and engages the arcuate leading edge portion 74. As a result, the king pin slides smoothly past the jaw bolt 36 without sticking or binding deep into the throat of the head assembly 10. Simultaneously, the engagement of the king pin with the jaw bolt 36 jiggles the jaw assembly 12 sufficiently to cause the shoulder 70 in the control handle 34 to be released from the margin of the side wall 56 defining the aperture 54. As a result the spring 38 biases the jaw assembly 12 to the closed position thereby capturing the king pin in the throat 32 of the head assembly 18 as soon as it clears the front edge of the jaw bolt. The biased or trimmed corner 76 at the front portion of the leading edge 72 ensures smooth quick closing action and proper capture of the king pin.

Once closed, the operator secures the trailer connection by inserting a connecting pin or padlock in the aligned apertures 78, 80 of the cooperating brackets 82, 84 carried, respectively, on the control handle 34 and the side wall 56 of the head assembly 18. This completes the connection for towing.

The foregoing description of a preferred embodiment of the invention has been presented for purposes of illustration and description. It is not intended to be exhaustive or to limit the invention to the precise form disclosed. Obvious modifications or variations are possible in light of the above teachings. For example, while the illustrated support frame 13 includes rails 14, side brackets 16 and a head support 17, other structural arrangements are envisioned with or without any of these individual components. Other skid plate 30 designs could also be used.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

In the claims:

1. A fifth wheel hitch assembly, comprising:
a frame;
a head assembly pivotally mounted to said frame; and
a jaw assembly connected to said head assembly, said jaw assembly including a control handle, a jaw bolt displaceable between an open position and a locking position and a biasing element urging said jaw bolt toward said locking position;
said jaw bolt being characterized by having an arcuate edge portion having a radius of curvature of between about 1.24 inches to about 3.24 inches.

2. A fifth wheel hitch assembly, comprising:
a frame;
a head assembly pivotally mounted to said frame; and
a jaw assembly connected to said head assembly, said jaw assembly including a control handle, a jaw bolt displaceable between an open position and a locking position and a biasing element for urging said jaw bolt toward said locking position;
said jaw bolt being characterized by having an arcuate edge portion having a radius of curvature of about 2.24 inches.

3. A jaw assembly for a fifth wheel hitch assembly, comprising:
a control handle;
a jaw bolt connected to said control handle;
a biasing element; and
said jaw bolt being characterized by having an arcuate edge portion having a radius of curvature of between about 1.24 inches to about 3.24 inches.

4. A jaw assembly for a fifth wheel hitch assembly, comprising:
a control handle;
a jaw bolt connected to said control handle;
a biasing element; and
said jaw bolt being characterized by having an arcuate edge portion having a radius of curvature of about 2.24 inches.

5. A fifth wheel hitch assembly, comprising:
a frame;
a head assembly pivotally mounted to said frame; and
a jaw assembly connected to said head assembly, said jaw assembly including a control handle, a jaw bolt displaceable between an open position and a locking position and a biasing element for urging said jaw bolt toward said locking position;
said jaw assembly being characterized by said biasing element being concentrically received around said control handle and having a first end engaging said head assembly and a second end engaging said jaw bolt.

6. The fifth wheel hitch assembly of claim 5, wherein said head assembly includes a rear wall, a top wall, a side wall and a base plate wherein said rear wall, top wall and base plate all include an opening for passage of a trailer king pin.

7. The fifth wheel hitch assembly of claim 6, further including at least one guide tab on said base plate, said at least one guide tab, said base plate, said rear wall and said top wall defining a guide track for said jaw bolt.

8. The fifth wheel hitch assembly of claim 7, wherein said side wall includes an aperture and said control handle extends through said aperture.

9. The fifth wheel hitch assembly of claim 8, further including a skid plate secured to said head assembly.

10. The fifth wheel hitch assembly of claim 9, further including a first locking bracket connected to said control handle and a second, cooperating locking bracket connected to said head assembly.

11. The fifth wheel hitch assembly of claim 6, wherein said first end of said biasing element engages said side wall of said head assembly.

12. The fifth wheel hitch assembly of claim 11, wherein said biasing element is a helical compression spring.

13. The fifth wheel hitch assembly of claim 5 wherein said jaw bolt includes a leading edge having an arcuate portion and a trimmed/biased corner.

14. The fifth wheel hitch assembly of claim 13, wherein said arcuate portion has a radius of curvature of between about 1.24 inches and about 3.24 inches.

15. The fifth wheel hitch assembly of claim 13, wherein said arcuate portion has a radius of curvature of about 2.24 inches.
